(19) United States
(12) Patent Application Publication
(10) Pub. No.: US 2021/0242733 A1
(43) Pub. Date: Aug. 5, 2021

(54) MOTOR ASSEMBLY AND MOTOR ROTOR

(71) Applicant: GRENERGY OPTO, INC., Hsinchu City (TW)

(72) Inventors: SHAN-NAN CHEN, Hsinchu City (TW); SHENG-WEN CHEN, Hsinchu City (TW)

(21) Appl. No.: 16/983,152

(22) Filed: Aug. 3, 2020

(30) Foreign Application Priority Data
Feb. 5, 2020 (TW) 109103474

(51) Int. Cl. H02K 1/27; H02K 1/30; H02K 1/18; H02K 1/14; H02K 9/22; H02K 3/28

(52) U.S. Cl. CPC H02K 1/278; H02K 1/30; H02K 3/28; H02K 1/146; H02K 9/22; H02K 1/182

(57) ABSTRACT

A motor assembly and a motor rotor are provided. The motor rotor includes a mandrel, a carrier, a plurality of iron cores, and a plurality of magnets. The outer edge of the carrier has a plurality of protrusions that are spaced apart from each other. A setting groove is formed between any two of the protrusions adjacent to each other. The iron cores are respectively fixed on the setting grooves. Each of the iron cores does not contact each other, so that an accommodating space is formed between any two of the iron cores adjacent to each other. One of two ends of each of the iron cores has a convex portion, so that each of the iron cores is connected to the corresponding setting groove through the convex portion thereof. The magnets are respectively disposed in the accommodating spaces.

### CROSS-REFERENCE TO RELATED PATENT APPLICATION

This application claims the benefit of priority to Taiwan Patent Application No. 109103474, filed on Feb. 5, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor assembly and a motor rotor that are capable of increasing magnetic flux.

### BACKGROUND OF THE DISCLOSURE

Permanent-magnet synchronous motors can be classified into two types: surface mounted permanent magnet motor (i.e., SPM) and interior permanent magnet motor (i.e., IPM), with the surface mounted permanent magnet motor being the most widely used. The surface mounted permanent magnet motor includes a plurality of magnets, a plurality of rotor cores, and a stator. The magnets are respectively attached on the outer surface of the rotor cores, and the other part of the outer surface of the rotor cores without the magnets and the outer surface of the stator have a fairly wide air gap there-between. Compared with the interior permanent magnet motor, the surface mounted permanent magnet motor has the advantages of a wider air gap, smaller armature reaction, smaller total distortion ratio of magnetic field waveform, current waveform, and voltage waveform, and lower vibration noise. Therefore, high-performance speed-regulated permanent magnet motors on the market mainly use the surface mounted permanent magnet motors.

However, the performance of the permanent magnet motor depends on the total magnetic flux, and the conventional surface mounted permanent magnet motors have a plurality of magnets attached to the outer surface of the rotor cores. In other words, the total magnetic flux of the conventional surface mounted permanent magnet motor is limited by the outer surface area of the rotor thereof. Therefore, the size of the rotor of the conventional surface mounted permanent magnet motor will need to be increased so as to increase the total magnetic flux thereof, so as to improve the motor performance. However, increasing the size of the rotor causes the volume of the conventional surface mounted permanent magnet motor to also increase. In other words, under the same volume, the conventional surface mounted permanent magnet motor is limited by the outer surface of the rotor and cannot be improved.

### SUMMARY OF THE DISCLOSURE

In response to the above-referenced technical inadequacies, the present disclosure provides a motor assembly and a motor rotor to effectively improve the issues associated with conventional permanent magnet motors.

In one aspect, the present disclosure provides a motor assembly, which includes a motor rotor and a motor stator. The motor rotor includes a mandrel, a carrier, a plurality of iron cores, and a plurality of magnets. The carrier is disposed on the mandrel. The carrier is made of non-magnetic material. An outer edge of the carrier has a plurality of protrusions that are spaced apart from each other, and a setting groove is formed between any two of the protrusions adjacent to each other. Each of the setting grooves is in a shape of a dovetail. The iron cores are respectively fixed on the setting grooves. The iron cores do not contact each other, so that an accommodating space is formed between any two of the iron cores adjacent to each other. Each of the iron cores has two opposite ends, and one of two ends of each of the iron cores has a first convex portion that is in a shape of a dovetail, so that each of the iron cores is connected to the corresponding setting groove through the first convex portion thereof. Two opposite sides of another one of the two ends of each the iron cores have a baffle portion, respectively. The magnets are respectively disposed in the accommodating spaces. In each of the accommodating spaces, the baffle portions of two corresponding ones of the iron cores adjacent to each other limit the movement of the magnet. The motor stator is assembled on a peripheral portion of the motor rotor. The motor stator includes a plurality of winding frames and a plurality of wires. The winding frames each have an installed end and an arranged end that is opposite to the installed end. Each of the installed ends has two opposite sides, one side of each of the installed ends has a second convex portion, and the other one side of each of the installed ends has a concave portion that is configured to connect to the second convex portion. In any two of the winding frames adjacent to each other, the second convex portion of one of the two winding frames and the concave portion of another one of the two winding frames are engaged with each other. Any two of the arranged ends of the winding frames adjacent to each other are provided with a gap there-between, and the arranged end of each of the winding frames has an end surface facing the motor rotor. The end surface of each of the arranged ends has two semicircular grooves that are spaced apart from each other, and a diameter of each of the two semicircular grooves is equal to a distance of the gap. The two semicircular grooves of each of the end surfaces are provided with a predetermined arc length there-between. Each of the predetermined arc lengths is ⅓ of an arc length of each of the end surfaces, so that the arc length of each of the end surfaces is divided into three equal portions. The wires are wound on the winding frames.

In certain embodiments, the present disclosure provides a motor rotor, which includes a mandrel, a carrier, a plurality of iron cores, and a plurality of magnets. The carrier is disposed on the mandrel. The carrier is disposed on the mandrel. The carrier is made of non-magnetic material. An outer edge of the carrier has a plurality of protrusions that are spaced apart from each other, and a setting groove is formed between any two of the protrusions adjacent to each other. Each of the setting grooves is in a shape of a dovetail. The iron cores are respectively fixed on the setting grooves. The iron cores do not contact each other, so that an accommodating space is formed between any two of the iron cores adjacent to each other. Each of the iron cores has two opposite ends, and one of two ends of each of the iron cores has a first convex portion that is in a shape of a dovetail, so that each of the iron cores is connected to the corresponding setting groove through the first convex portion thereof. Two opposite sides of another one of the two ends of each the iron cores have a baffle portion, respectively. The magnets are respectively disposed in the accommodating spaces. In each of the accommodating spaces, the baffle portions of two corresponding ones of the iron cores adjacent to each other limit the movement of the magnet.

Therefore, the motor assembly and the motor rotor of the present disclosure are designed to provide the accommodating spaces by spacing apart the iron cores from each other on the carrier, so that the magnets can respectively arrange in the accommodation spaces along a corresponding axial direction of the mandrel. Accordingly, the magnets arranged in the motor rotor are configured to provide a more effective area to increase the total magnetic flux of the motor assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic perspective view of a motor assembly according to a first embodiment of the present disclosure.

FIG. 2 is a schematic partial exploded view of the motor assembly according to the first embodiment of the present disclosure.

FIG. 3 is a schematic exploded view of a motor rotor of the motor assembly according to the first embodiment of the present disclosure.

FIG. 4 is a schematic cross-sectional view taken along line IV-IV of FIG. 2.

FIG. 5 is a schematic partial exploded view of a motor stator of the motor assembly according to the first embodiment of the present disclosure.

FIG. 6 is a schematic assembled perspective view of a plurality of winding frames and a plurality of wires that are connected to the winding frames according to the first embodiment of the present disclosure.

FIG. 7 is a schematic exploded perspective view of FIG. 6.

FIG. 8 is a schematic top view of the motor assembly according to the first embodiment of the present disclosure.

FIG. 9 is a schematic enlarged view of section IX of FIG. 8.

FIG. 10 is a schematic cross-sectional view of a motor assembly according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

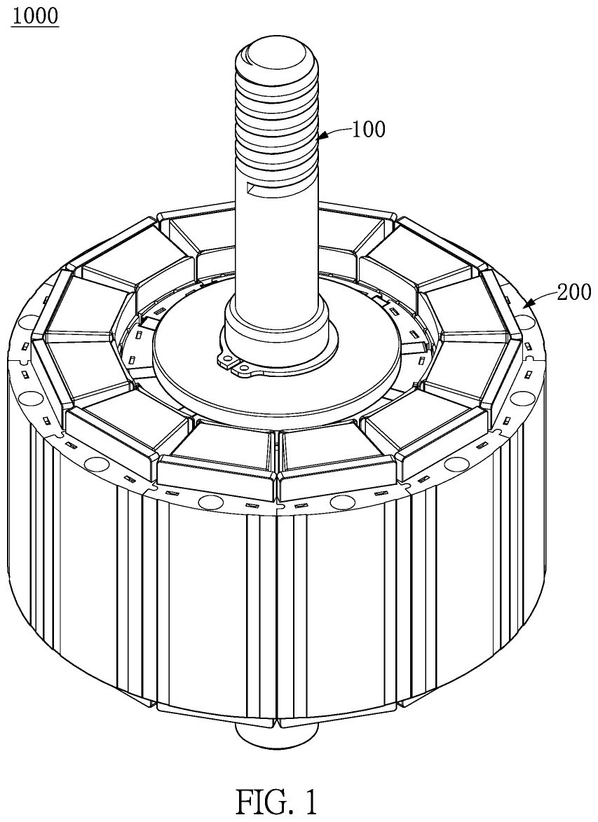

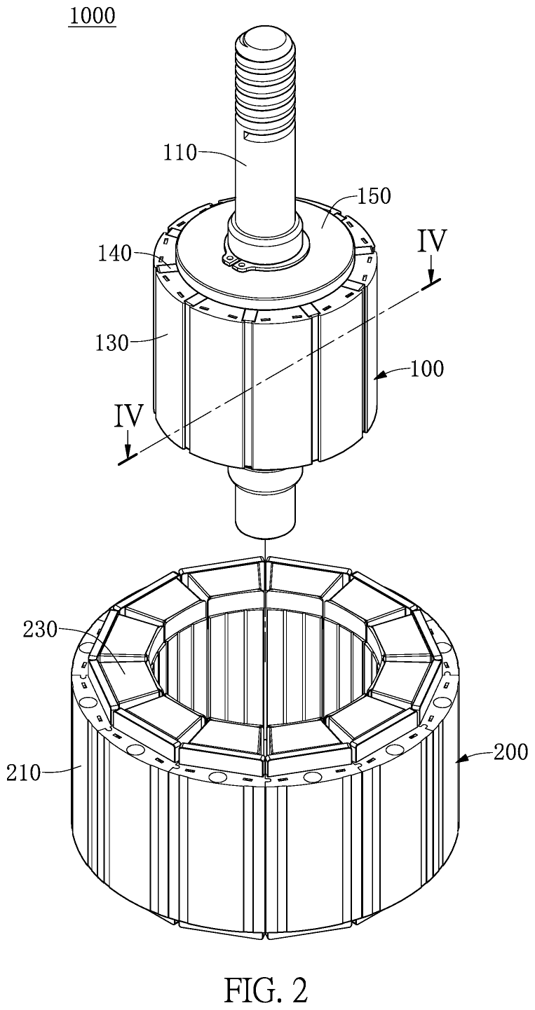

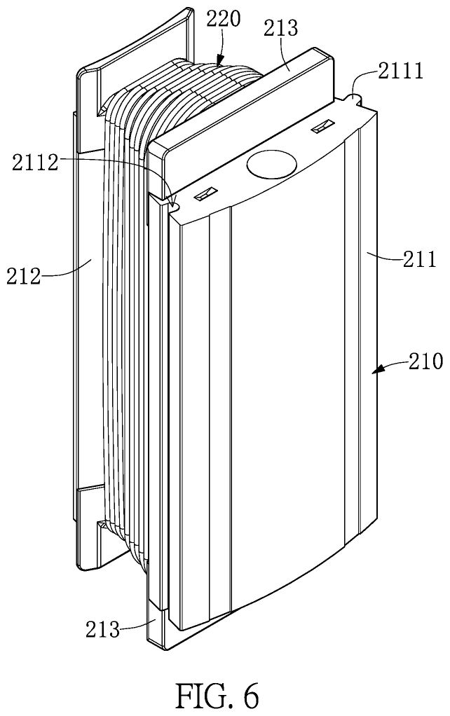

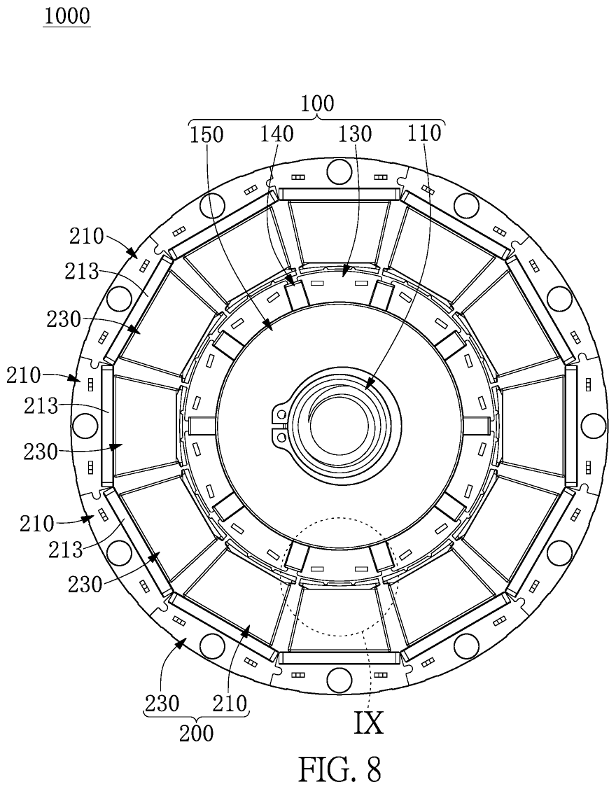

Referring to FIG. 1 to FIG. 9, a first embodiment of the present disclosure provides a motor assembly 1000. The motor assembly 1000 in the present embodiment is a structure that has ten poles and twelve slots, but the present disclosure is not limited thereto. The motor assembly 1000 includes a motor rotor 100 and a motor stator 200 that is assembled on a peripheral portion of the motor rotor 100 (as shown in FIGS. 1 and 2). It should be noted that the motor rotor 100 and the motor stator 200 in the present embodiment are jointly defined as the motor assembly 1000, but the present disclosure is not limited thereto. For example, in other embodiments of the present disclosure, the motor rotor 100 can be independently used (e.g., sold) or can be used in cooperation with other components. The following description describes the structure and connection relationship of each component of the motor assembly 1000.

Referring to FIG. 2 to FIG. 4, the motor rotor 100 includes a mandrel 110, a carrier 120 disposed on the mandrel 110, a plurality of iron cores 130 disposed on the carrier 120, a plurality of magnets 140 respectively disposed between the iron cores 130, and two baffle sheets 150 that are respectively disposed on two sides of the carrier 120. Specifically, any one of the magnets 140 of the motor rotor 100 is disposed between any two of the iron cores 130 adjacent to each other. In other words, any motor rotor that does not provide a plurality of magnets respectively disposed between any two of the iron cores adjacent to each other is not the motor rotor 100 of the present embodiment.

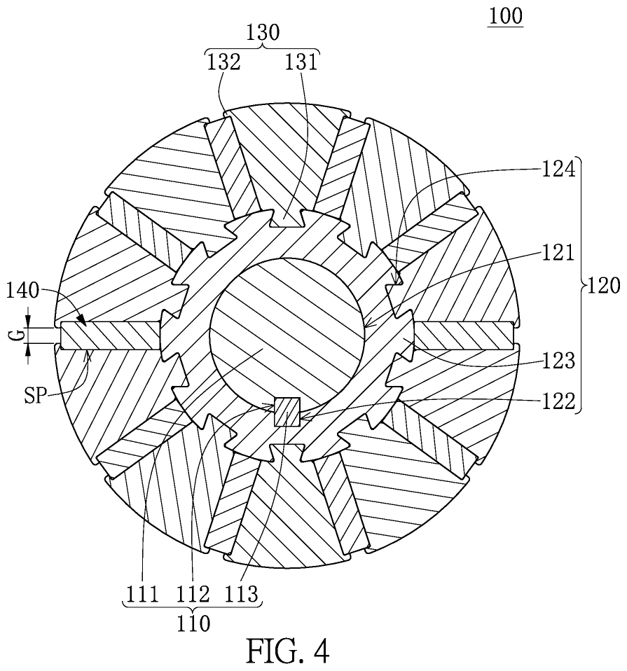

The mandrel 110 is made of medium carbon steel with magnetic properties. Specifically, the mandrel 110 has a shaft 111, a limiting groove 112 disposed on the shaft 111, and a limiting block 113 that is disposed in the limiting groove 112. The part of the limiting block 113 protrudes from the limiting groove 112 (as shown in FIG. 4).

The carrier 120 is made of a non-magnetic material. The non-magnetic material of the carrier 120 in the present embodiment is aluminum or aluminum alloy, but the present disclosure is not limited thereto. For example, in other embodiments of the present disclosure, the non-magnetic material of the carrier 120 may be copper, non-magnetic stainless steel, copper alloy, or reinforced plastic.

The carrier 120 is fixed on the mandrel 110. Specifically, the carrier 120 is a ring frame structure, so as to have a through hole 121. A snap groove 122 is formed in the inner edge of the through hole 121 of the carrier 120. The carrier 120 is sleeved around the mandrel 110 by the through hole 121, and the snap groove 122 and the limiting block 113 of the mandrel 110 are engaged with each other, so that the carrier 120 and the mandrel 110 can be synchronously rotating. The carrier 120 has a plurality of protrusions 123 that are arranged on an outer side thereof and that are spaced apart from each other, so that a setting groove 124 is formed between any two of the protrusions 123 adjacent to each other. In detail, a cross section of each of the setting grooves 124 perpendicular to a radial direction of the mandrel 110 is tapered along a direction that extends away from the mandrel 110, and a cross section of each of the protrusions 123 perpendicular to the radial direction of the mandrel 110 is broadened along the direction that extends away from the mandrel 110. In other words, each of the setting grooves 124 is in a shape of a dovetail.

The iron cores 130 are respectively fixed in the setting grooves 124. The iron cores 130 do not contact each other, so that an accommodating space SP is formed between any two of the iron cores 130 adjacent to each other. In detail, each of the iron cores 130 in the present embodiment is composed of a plurality of silicon steel sheets, but the present disclosure is not limited thereto.

Each of the iron cores 130 has two opposite ends, and one of the two ends of each of the iron cores 130 has a first convex portion 131. A cross section of each of the first convex portions 131 protruding in the radial direction of the mandrel 110 broadens along a direction that extends toward the mandrel 110, so that each of the iron cores 130 is connected to the corresponding setting groove 124 through the first convex portion 131 thereof. In other words, each of the first convex portions 131 is in a shape of a dovetail, and is configured to be fixed in the setting groove 124 that is in the shape of a dovetail. Two opposite sides of the other one of the two ends of each of the iron cores 130 have a baffle portion 132, respectively.

Specifically, the two opposite sides of the other end of any one of the iron cores 130 respectively have the baffle portions 132 that protrude outward. In two of the iron cores 130 adjacent to each other, two of the baffle portions 132 facing each other have a predetermined distance G there-between, so that two of the baffle portions 132 do not contact each other. The predetermined distance G is within a range of 1 to 3 mm. The predetermined distance G in the present embodiment is 2.5 mm, but the present disclosure is not limited thereto.

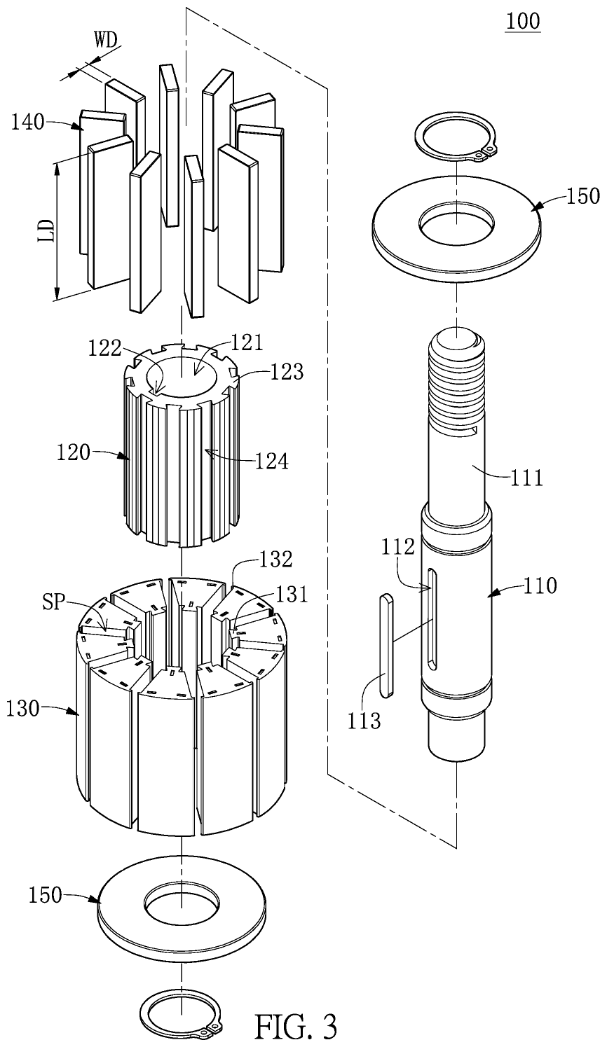

The magnets 140 are respectively disposed in the accommodating spaces SP. In each of the accommodating spaces SP, the baffle portions 132 of two of the iron cores 130 are configured to limit the movement of the magnet 140. Further, each of the magnets 140 in the present embodiment is a rectangular sheet structure, and the total quantity of the magnets 140 is ten. Each of the magnets 140 has a width WD relative to a radial cross-section of the mandrel 110 within a range of 2 to 8 mm (as shown in FIG. 3). Each of the magnets 140 has a length LD along an axial direction of the mandrel 110, and the length LD of each of the magnets 140 is equal to a distance of the corresponding accommodating space SP that is along the axial direction of the mandrel 140 (as shown in FIG. 2), but the present disclosure is not limited thereto. For example, in other embodiments of the present disclosure, the length LD of each of the magnets 140 may be adjusted to be greater or less than the distance of the corresponding accommodating space SP that is along the axial direction of the mandrel 110.

Specifically, each of the magnets 140 is disposed between two of the iron cores 130 adjacent to each other in the radial direction of the core shaft 110. In other words, the magnets 140 are arranged on the carrier 120 in a radiation configuration, so as to have more effective area that can increase the magnetic flux. In other words, any motor rotor that is not disposed on the carrier in the radiation configuration is not the motor rotor 100 of the present embodiment.

The two baffle sheets 150 are respectively disposed on two rim sides of the carrier 120, and the two baffle sheets 150 are configured to limit the movement of the iron cores 130 and the magnets 140. Specifically, each of the two baffle sheets 150 in the present embodiment is a disc-like structure. The two baffle sheets 150 are made of non-magnetic material (e.g., aluminum, aluminum alloy, copper, copper alloy, or non-magnetic stainless steel). The two baffle sheets 150 are respectively disposed on the mandrel 110 and located on both sides of the carrier 120. A radius of each of the two baffle sheets 150 is equal to or less a radius of the carrier 120. The two baffle sheets 150 can limit the movement of each of the iron cores 130 and each of the magnets 140, so as to prevent each of the iron cores 130 and each of the magnets 140 from separating along the axial direction of the mandrel 110.

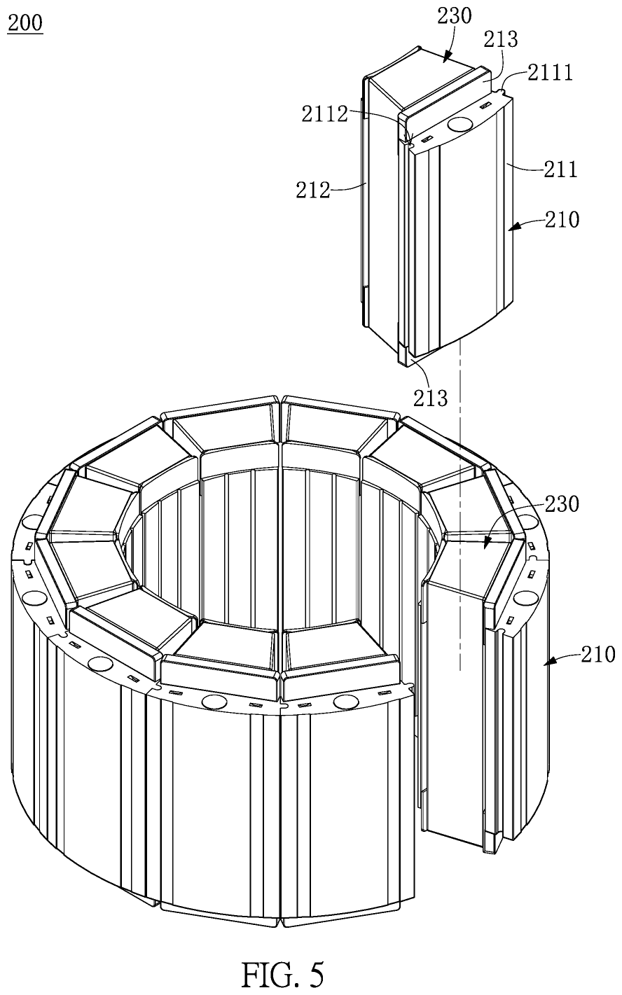

Referring to FIG. 5 to FIG. 7, the motor stator 200 is assembled on a peripheral portion of the motor rotor 100. The motor stator 200 includes a plurality of winding frames 210, a plurality of wires 220 wound around the winding frames 210, and a plurality of cooling colloids 230 that respectively and completely cover the wires.

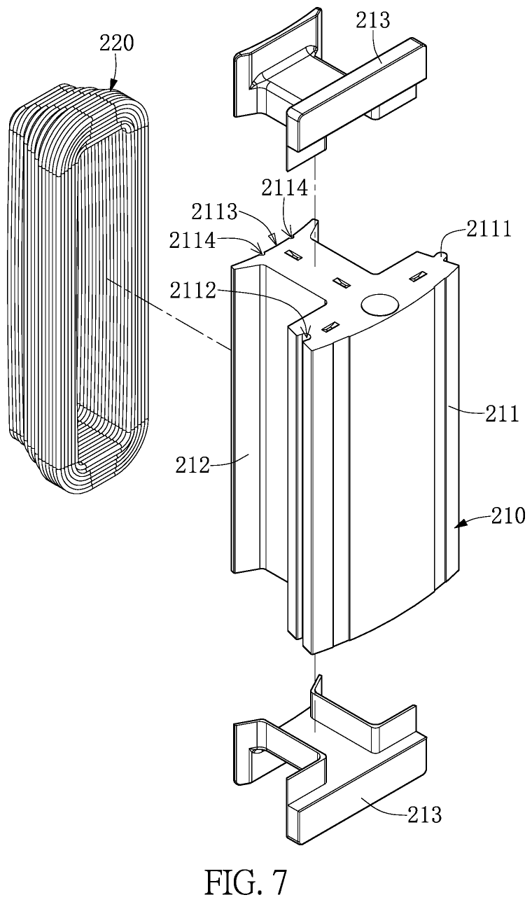

Referring to FIG. 7 (FIG. 7 does not show the cooling colloids 230), the winding frames 210 in the present embodiment are integrally formed by stamping, but the present disclosure is not limited thereto. For example, the winding frames 210 may be composed of a plurality of structures. The winding frames 210 each have an installed end 211 and an arranged end 212 that is opposite to the installed end 211. Each of the installed ends 211 has two opposite sides, one side of each of the installed ends 211 has a second convex portion 2111, and the other one side of each of the installed ends 211 has a concave portion 2112 that is configured to connect to the second convex portion 2111. In any two of the winding frames 210 adjacent to each other, the second convex portion 2111 of one of the two winding frames 210 and the concave portion 2112 of another one of the two winding frames 210 are engaged with each other. Specifically, the total quantity of the winding frames 210 in the present embodiment is twelve, and the winding frames 210 are arranged as a ring structure. The motor rotor 100 is sleeved around the center of the motor stator 200. Preferably, each of the winding frames 210 further has two end covers 213, and the two end covers 213 are disposed at two ends of the winding frame 210 in the axial direction of the mandrel 110, respectively.

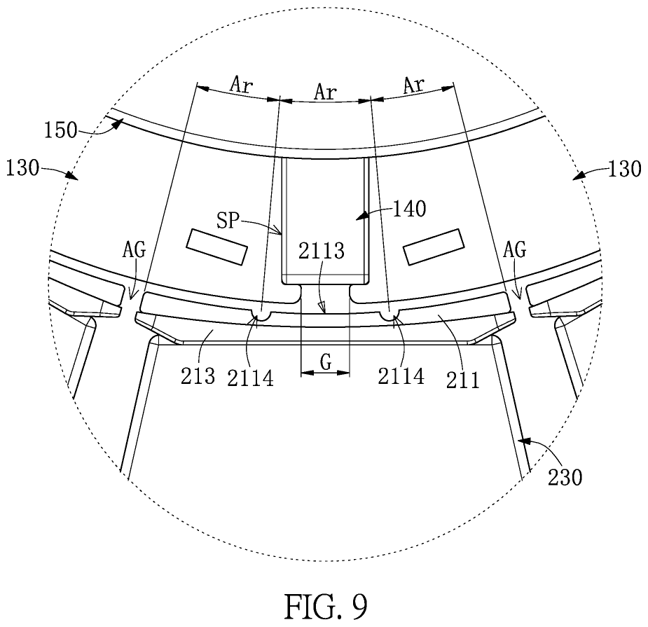

Referring to FIG. 7 to FIG. 9, in which any two of the arranged ends 212 of the winding frames 210 adjacent to each other are provided with a gap AG there-between (as shown in FIG. 9), and the arranged end 212 of each of the winding frames 210 has an end surface 2113 facing the motor rotor 100. The end surface 2113 of each of arranged ends 212 has two semicircular grooves 2114 that are spaced apart from each other, and a diameter of each the two semicircular grooves 2114 is equal to a distance of the gap AG. The two semicircular grooves 2114 of each of the end surfaces 2113 are provided with a predetermined arc length Ar there-between. Each of the predetermined arc lengths Ar is ⅓ of an arc length of each of the end surfaces 2113, so that the arc length of each of the end surfaces 2113 is divided into three equal portions.

In detail, the end surfaces 2113 of each of the winding frames 210 is a curved surface. The total quantity of the winding frames 210 in the present embodiment is twelve, so that both sides of the end surfaces 2113 of each of the winding frames 210 and a center point of the mandrel 110 jointly define an angle of 30 degrees. The two semicircular grooves 2114 of each of the end surfaces 2113 and the center point of the mandrel 110 jointly define an angle of 10 degrees. In each of the end surfaces 2113, any one of the two semicircular grooves 2114, one of the two sides that is adjacent to the any one of the two semicircular grooves 2114, and the center point of the mandrel 110 jointly define an angle of 10 degrees, but the present disclosure is not limited thereto.

In the two semicircular grooves 2114 of each of the end surfaces 2113, a cogging torque of one of the two semicircular grooves 2114 is capable of offsetting a cogging torque of another one of the two semicircular grooves 2114. Any one of the semicircular grooves 2114 of each of the end surfaces 2113 is capable of offsetting a cogging torque of the gap AG adjacent thereto. In other words, the two semicircular grooves 2114 of any one of the end surfaces 2113 can offset the cogging torque of two of the gaps AG that are adjacent thereto. Further, the number of the semicircular grooves 2114 of each of the end surfaces 2113 is determined by the highest common factor of the number of poles and slots of the motor assembly 1000. The motor assembly 1000 has ten poles and twelve slots, so that the highest common factor of the number of poles and slots of the motor assembly 1000 is two. The quantity of the semicircular grooves 2114 of each of the end surfaces 2113 is two, but the present disclosure is not limited thereto. For example, in other embodiments of the present disclosure, when the motor assembly 1000 has eight poles and twelve slots, the highest common factor is four. That is to say, the number of the semicircular grooves 2114 of each of the end surfaces 2113 is four.

Referring to FIG. 5 and FIG. 7, the wires 220 individually wound on the winding frames 210, respectively. The cooling colloids 230 respectively and completely cover the wires 220. The cooling colloids 230 in the present embodiment are thermally conductive adhesives with high thermal conductivity and high insulation coefficient. Specifically, in each of the winding frames 210, a cross section of any one of the two end covers 213 is larger than a cross section of the two ends of the winding frame 210. In each of the winding frames 210, the two end covers 213 are respectively disposed on two ends of the winding frames 210, so that the two ends of the winding frames 210 are covered by the two end covers 213. In each of the winding frames 210, when the wire 220 is wound through the two end covers 213, a gap is maintained between the wire 220 and the side of the winding frame 210 through the thickness of the two end covers 213. Each of the cooling colloids 230 can fill the gap between the wires 220 and the winding frames 210, so that the wire 220 does not directly contact the winding frame 210. In other words, any one of the cooling colloids 230 completely covers the corresponding wire 220, and separates the wire 220 and the winding frame 210. The cooling colloids 230 may completely cover the wires 220 in a vacuum environment, but the present disclosure is not limited thereto.

### Second Embodiment

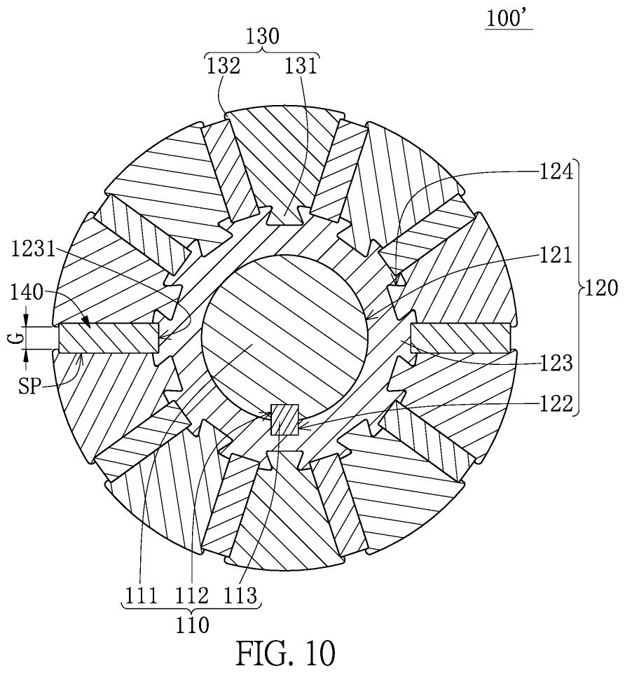

Referring to FIG. 10, a second embodiment of the present disclosure provides a motor rotor 100′. In the motor rotor 100′, each of the protrusions 123 arranged on the carrier 120 has a groove 1231, and a position of the groove 1231 corresponds to a position of the corresponding accommodating space SP. The magnets 140 are respectively disposed in the grooves 1231, and part of any one of the magnets 140 is located in the corresponding accommodating space SP. In other words, each of the grooves 1231 is in spatial communication with the corresponding accommodating space SP. Accordingly, the motor rotor 100′ can have a more effective area through the magnets 140 and the design of the grooves 1231.

In conclusion, the motor assembly 1000 and the motor rotor 100 of the present disclosure are designed to provide the accommodating spaces SP by spacing apart the iron cores 130 from each other on the carrier 120, so that the magnets 140 can respectively arrange in the accommodation spaces SP along an axial direction of the mandrel 110. Accordingly, the magnets 140 arranged in the motor rotor 100 are configured to provide a more effective area to increase the total magnetic flux of the motor assembly 1000.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor assembly, comprising:
a motor rotor including:
a mandrel;
a carrier disposed on the mandrel, wherein the carrier is made of non-magnetic material, wherein an outer edge of the carrier has a plurality of protrusions that are spaced apart from each other, and a setting groove is formed between any two of the protrusions adjacent to each other, and wherein each of the setting grooves is in a shape of a dovetail;
a plurality of iron cores respectively fixed on the setting grooves, wherein the iron cores do not contact each other, so that an accommodating space is formed between any two of the iron cores adjacent to each other, wherein each of the iron cores has two opposite ends, and one of two ends of each of the iron cores has a first convex portion that is in a shape of a dovetail, so that each of the iron cores is connected to the corresponding setting groove through the first convex portion thereof, and wherein two opposite sides of another one of the two ends of each the iron cores have a baffle portion, respectively; and
a plurality of magnets respectively disposed in the accommodating spaces, wherein in each of the accommodating spaces, the baffle portions of two corresponding ones of the iron cores adjacent to each other limit the movement of the magnet; and
a motor stator assembled on a peripheral portion of the motor rotor, wherein the motor stator includes:
a plurality of winding frames each having an installed end and an arranged end that is opposite to the installed end, wherein each of the installed ends has two opposite sides, one side of each of the installed ends has a second convex portion, and the other one side of each of the installed ends has a concave portion that is configured to connect to the second convex portion, wherein in any two of the winding frames adjacent to each other, the second convex portion of one of the two winding frames and the concave portion of another one of the two winding frames are engaged with each other, wherein any two of the arranged ends of the winding frames adjacent to each other are provided with a gap there-between, and the arranged end of each of the winding frames has an end surface facing the motor rotor, wherein the end surface of each of the arranged ends has two semicircular grooves that are spaced apart from each other, and a diameter of each of the two semicircular grooves is equal to a distance of the gap, wherein the two semicircular grooves of each of the end surfaces are provided with a predetermined arc length there-between, and wherein each of the predetermined arc lengths is ⅓ of an arc length of each of the end surfaces, so that the arc length of each of the end surfaces is divided into three equal portions, and
a plurality of wires wound on the winding frames.

2. The motor assembly according to claim 1, wherein in any two of the iron cores adjacent to each other, two of the baffle portions facing each other have a predetermined distance within a range of 1 to 3 mm there-between, and wherein each of the magnets is a rectangular sheet structure, and each of the magnets has a width relative to a radial cross-section of the mandrel within a range of 2 to 8 mm.

3. The motor assembly according to claim 1, wherein each of the protrusions has a groove, and a position of the groove corresponds to a position of the corresponding accommodating space, and wherein the magnets are respectively disposed in the grooves, and part of any one of the magnets is located in the corresponding accommodating space.

4. The motor assembly according to claim 1, wherein each of the magnets has a length along an axial direction of the mandrel, and the length of each of the magnets is equal to a distance of the corresponding accommodating space that is along the axial direction of the mandrel.

5. The motor assembly according to claim 1, wherein the motor rotor further includes two baffle sheets that are respectively disposed on two rim sides of the carrier, and the two baffle sheets are configured to limit the movement of the iron cores and the magnets.

6. The motor assembly according to claim 1, wherein the motor stator further includes a plurality of cooling colloids that respectively and completely cover the wires.

7. A motor rotor, comprising:
a mandrel;
a carrier disposed on the mandrel, wherein the carrier is made of non-magnetic material, wherein an outer edge of the carrier has a plurality of protrusions that are spaced apart from each other, and a setting groove is formed between any two of the protrusions adjacent to each other, and wherein each of the setting grooves is in a shape of a dovetail;
a plurality of iron cores respectively fixed on the setting grooves, wherein the iron cores do not contact each other, so that an accommodating space is formed between any two of the iron cores adjacent to each other, wherein each of the iron cores has two opposite ends, and one of two ends of each of the iron cores has a first convex portion that is in a shape of a dovetail, so that each of the iron cores is connected to the corresponding setting groove through the first convex portion thereof, and wherein two opposite sides of another one of the two ends of each the iron cores have a baffle portion, respectively; and
a plurality of magnets respectively disposed in the accommodating spaces, wherein in each of the accommodating spaces, the baffle portions of two corresponding ones of the iron cores adjacent to each other limit the movement of the magnet.

8. The motor rotor according to claim 7, wherein in any two of the iron cores adjacent to each other, two of the baffle portions facing each other have a predetermined distance within a range of 1 to 3 mm there-between, and wherein each of the magnets is a rectangular sheet structure, and each of the magnets has a width relative to a radial cross-section of the mandrel within a range of 2 to 8 mm.

9. The motor rotor according to claim 7, wherein each of the protrusions has a groove, and a position of the groove corresponds to a position of the corresponding accommodating space, and wherein the magnets are respectively disposed in the grooves, and part of any one of the magnets is located in the corresponding accommodating space.

10. The motor rotor according to claim 7, further composing two baffle sheets that are respectively disposed on two rim sides of the carrier, and the two baffle sheets are configured to limit the movement of the iron cores and the magnets.
